(19) United States
(12) Patent Application Publication
(10) Pub. No.: US 2020/0077073 A1
(43) Pub. Date: Mar. 5, 2020

(54) REAL-TIME STEREO CALIBRATION BY DIRECT DISPARITY MINIMIZATION AND KEYPOINT ACCUMULATION

(71) Applicant: QUALCOMM Incorporated, San Diego, CA (US)

(72) Inventors: James Nash, San Diego, CA (US); Kalin Atanassov, San Diego, CA (US); Narayana Karthik Ravirala, San Diego, CA (US)

(21) Appl. No.: 16/114,748

(22) Filed: Aug. 28, 2018

(51) Int. Cl. H04N 13/246; G06T 7/80; G06T 7/593; G06K 9/62

(52) U.S. Cl. CPC H04N 13/246; G06T 7/85; H04N 2013/0081; G06K 9/6215; G06T 7/593

(57) ABSTRACT

A stereoscopic imaging device is configured to capture multiple corresponding images of objects from a first camera and a second camera. The stereoscopic imaging device can determine multiple sets of keypoint matches based on the multiple corresponding images of objects, and can accumulate the keypoints. In some examples, the stereoscopic imaging device can determine a vertical disparity between the first camera and the second camera based on the multiple sets of keypoint matches. In some examples, the stereoscopic imaging device can determine yaw errors between the first camera and the second camera based on the sets of keypoint matches, and can determine a yaw disparity between the first camera and the second camera based on the determined yaw errors. The stereoscopic imaging device can generate calibration data to calibrate one or more of the first camera and the second camera based on the determined vertical disparity and/or yaw disparity.

### CROSS-REFERENCE TO RELATED APPLICATIONS

None.

### STATEMENT ON FEDERALLY SPONSORED RESEARCH OR DEVELOPMENT

None.

### BACKGROUND

### Field of the Disclosure

This disclosure relates generally to stereo cameras and, more specifically, to stereo camera calibration.

### Description of Related Art

Stereo cameras allow for the capture of three-dimensional images. Image capture devices that employ stereo cameras include smart phones, cell phones, tablets, and laptop computers, among others. The stereo cameras enable various features in the image capturing devices, such as dense depth mapping, bokeh effect, wide angle and telephoto smooth zoom, that allow for high quality video and still images. Stereo cameras also enable visual odometry for Augmented Reality (AR) or Virtual Reality (VR), among other functionality. Feature performance, however, depends critically on depth accuracy. Depth accuracy depends on the accuracy of camera parameters which are used to estimate image depth. For example, stereo camera parameters are used to minimize vertical disparity in corresponding images taken by left and right cameras of a stereo camera system.

Initial static calibration of stereo camera parameters is performed in a factory setting with specialized charts and under controlled conditions. For example, the initial static calibration can include calibrating stereo parameters based on locating keypoints in corresponding images of a specialized chart taken by left and right cameras of a stereo camera system. However, the controlled conditions are typically not duplicated when the stereo camera is used after leaving the factory (e.g., in real life). For example, the stereo cameras may experience some degree of relative motion due to aging, jarring, shock, or warping. These experiences can affect the validity of initial stereo camera parameter calibration. For example, these experiences can cause greater vertical disparity in corresponding images taken by left and right cameras of a stereo camera system. As such, there are opportunities to improve stereo camera parameter calibration in stereo cameras.

### SUMMARY

In some examples a method of calibrating a stereoscopic imaging device includes capturing a first image of a first object from a first camera of the stereoscopic imaging device, and capturing a second image of the first object from a second camera of the stereoscopic imaging device. The method can include determining a first set of keypoint matches based on the first and second images of the first object. The method can include capturing a first image of a second object from the first camera of the stereoscopic imaging device, and capturing a second image of the second object from the second camera of the stereoscopic imaging device. The method can include determining a second set of keypoint matches based on the first and second images of the second object.

The method can include determining a vertical disparity between the first camera and the second camera based on the first set of keypoint matches and the second set of keypoint matches. The method can also include generating calibration data based on the determined vertical disparity to calibrate one or more of the first camera and second camera of the stereoscopic imaging device.

In some examples, a method for correcting a yaw disparity between a first camera and a second camera of a stereoscopic imaging device includes capturing a first image of a first object from the first camera of the stereoscopic imaging device and a second image of the first object from the second camera of the stereoscopic imaging device. The method can include capturing a first image of a second object from the first camera of the stereoscopic imaging device and a second image of the second object from the second camera of the stereoscopic imaging device. The method can include determining a first set of keypoint matches based on the first and second images of the first object, and determining a second set of keypoint matches based on the first and second images of the second object.

The method can include computing a first yaw error between the first camera and the second camera based on the first set of keypoint matches, and computing a second yaw error between the first camera and the second camera based on the second set of keypoint matches. The method can include determining the yaw disparity between the first camera and the second camera based on the first yaw error and the second yaw error. The method can also include generating yaw calibration data based on the determined yaw disparity to calibrate one or more of the first camera and second camera of the stereoscopic imaging device. In some examples, the method includes correcting the yaw disparity between the first camera and the second camera based on the determined yaw disparity between the first camera and the second camera. For example, one or more camera yaw parameters are adjusted to correct the yaw disparity between the first camera and the second camera.

In some examples, a method of calibrating a stereoscopic imaging device includes capturing a first image of a first scene from a first camera of the stereoscopic imaging device, and capturing a second image of the first scene from a second camera of the stereoscopic imaging device. In some examples, the scene includes a first object and a second object each with at least one known dimension. The method can include determining a depth of the first object based on the known dimension for the first object and a focal parameter, and determining a depth of the second object based on the known dimension for the second object and the focal parameter. The method can include determining a first set of keypoint matches based on the first and second images of the scene, and determining a vertical disparity between the first camera and the second camera based on the first set of keypoint matches. The method can include generating calibration data based on the determined vertical disparity to calibrate at least one of the first camera and second camera of the stereoscopic imaging device.

In some examples, a stereoscopic imaging device includes electronic circuitry, such as one or more processors, configured to carry out one or more steps of the above methods.

In some examples, a non-transitory, computer-readable storage medium includes executable instructions. The executable instructions, when executed by one or more processors, can cause the one or more processors to carry out one or more of the steps of the above methods.

### BRIEF DESCRIPTION OF DRAWINGS

FIG. 1 is a block diagram of an exemplary stereoscopic imaging system including an accumulated keypoint based image analysis system;

FIG. 2 is a block diagram of a more detailed view of the exemplary accumulated keypoint based image analysis system of FIG. 1;

FIG. 3A illustrates a diagram of a focal plane including an optical axis extending to a chart center;

FIG. 3B illustrates a diagram showing yaw disparity between two cameras;

FIG. 4A is a block diagram of an imaging device with two cameras each in relation to a yaw axis;

FIG. 4B is a block diagram of the imaging device of FIG. 4A with one of the two cameras experiencing a yaw error due to a rotation about the yaw axis;

FIG. 5A illustrates a known object that can be used by the exemplary accumulated keypoint based image analysis system of FIG. 1 to calibrate stereo parameters;

FIG. 5B illustrates another known object that can be used by the exemplary accumulated keypoint based image analysis system of FIG. 1 to calibrate stereo parameters;

FIG. 6 is a flowchart of an example method that can be carried out by the exemplary accumulated keypoint based image analysis system of FIG. 1;

FIG. 7 is a flowchart of another example method that can be carried out by the exemplary accumulated keypoint based image analysis system of FIG. 1; and

FIG. 8 is a flowchart of yet another example method that can be carried out by the exemplary accumulated keypoint based image analysis system of FIG. 1.

### DETAILED DESCRIPTION

While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings. It should be understood, however, that the present disclosure is not intended to be limited to the particular forms disclosed. Rather, the present disclosure covers all modifications, equivalents, and alternatives that fall within the spirit and scope of these exemplary embodiments.

These disclosures provide a stereoscopic imaging system that includes stereo image calibration error detection and adjustment functionality based on accumulated keypoints. The stereoscopic imaging system identifies and stores keypoints in images taken at various points in time. The keypoints can be identified for known (e.g., recognized) objects in the image. For example, the stereoscopic imaging system can identify and store keypoints for known objects in images taken by a purchaser of the stereoscopic imaging system during everyday use. The stereoscopic imaging system can monitor the validity of stereo calibration parameters based on the accumulated keypoints. For example, when depth or yaw errors manifest, the stereoscopic imaging system can calibrate the stereo calibration parameters using the stored keypoints. The stereoscopic imaging system can then calibrate one or more stereo cameras based on the updated stereo calibration parameters.

Among other advantages, the stereoscopic imaging system can minimize vertical disparity and/or yaw errors in a stereo camera without needing to take the stereo camera back to a factory for calibration. For example, the stereoscopic imaging system can minimize vertical disparity and/or yaw errors in real-time. In addition, the stereoscopic imaging system can calibrate stereo camera parameters based on recently captured keypoints, which better reflect the current condition of the stereoscopic imaging system.

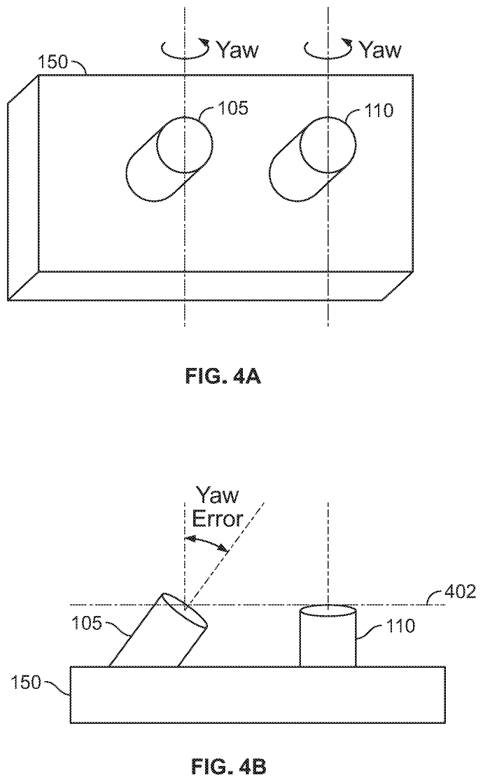

In some examples, a stereoscopic imaging system includes a first camera, a second camera, and an accumulated keypoint based image analysis device. The accumulated keypoint based image analysis device can capture images of objects from the first camera, and corresponding images of the objects from the second camera. For example, the accumulated keypoint based image analysis device can capture a first image of a first object from the first camera, and a second image of the first object from the second camera. The accumulated keypoint based image analysis device can capture a first image of a second object from the first camera, and a second image of the second object from the second camera. The first object and the second object can be known objects, such as the objects discussed below with respect to FIGS. 4A and 4B, with known dimensions.

The accumulated keypoint based image analysis device can determine keypoint matches based on the captured images. For example, the accumulated keypoint based image analysis device can determine a first set of keypoint matches (e.g., two or more keypoint matches) based on the first and second images of the first object, and determine a second set of keypoint matches based on the first and second images of the second object. The accumulated keypoint based image analysis device can then determine a vertical disparity between the first camera and the second camera based on the keypoint matches from multiple captured images. For example, the accumulated keypoint based image analysis device can determine the vertical disparity based on the first set of keypoint matches and the second set of keypoint matches.

The accumulated keypoint based image analysis device can generate calibration data based on the determined vertical disparity. For example, the calibration data can include updates to one or more camera parameters, such as a vertical disparity camera parameter used in calculating the vertical disparity between two cameras. The accumulated keypoint based image analysis device then calibrates at least one of the first camera and the second camera based on the generated calibration data.

In some examples, the accumulated keypoint based image analysis device includes a non-volatile storage device. The accumulated keypoint based image analysis device can be configured to store the sets of keypoint matches, such as the first set of keypoint matches and the second set of keypoint matches, in the non-volatile storage device. The accumulated keypoint based image analysis device can be configured to retrieve the first set of keypoints from the non-volatile storage device to determine the vertical disparity between the first camera and the second camera.

In some examples, the accumulated keypoint based image analysis device is configured to store image captured times in the non-volatile memory. For example, the accumulated keypoint based image analysis device can store a captured time of the first and second images of the first object, and a captured time of the first and second images of the second object, in the non-volatile memory device. In some examples, the accumulated keypoint based image analysis device is configured to determine that one or more sets of keypoints correspond to images captured within a window of time based on the captured times stored in the non-volatile memory device. For example, the accumulated keypoint based image analysis device can determine that the first and second images of the first object were captured within a window of time based on the captured time of the first and second images of the first object stored in the non-volatile memory device.

In some examples, a stereoscopic imaging device includes a first camera, a second camera, and an accumulated keypoint based image analysis device. The accumulated keypoint based image analysis device can capture a first image of a first object from the first camera and a second image of the first object from the second camera. The accumulated keypoint based image analysis device can capture a first image of a second object from the first camera and a second image of the second object from the second camera. The accumulated keypoint based image analysis device can determine a first set of keypoint matches based on the first and second images of the first object, and can determine a second set of keypoint matches based on the first and second images of the second object.

The accumulated keypoint based image analysis device can compute a first yaw error between the first camera and the second camera based on the first set of keypoint matches, and compute a second yaw error between the first camera and the second camera based on the second set of keypoint matches.

The accumulated keypoint based image analysis device can determine a yaw disparity between the first camera and the second camera based on the first yaw error and the second yaw error. The accumulated keypoint based image analysis device can also generate yaw calibration data based on the determined yaw disparity. The accumulated keypoint based image analysis device can store the generated yaw calibration data in a non-volatile, machine readable storage device.

The accumulated keypoint based image analysis device can calibrate (e.g., correct) at least one of the first camera and the second camera based on the generated yaw calibration data.

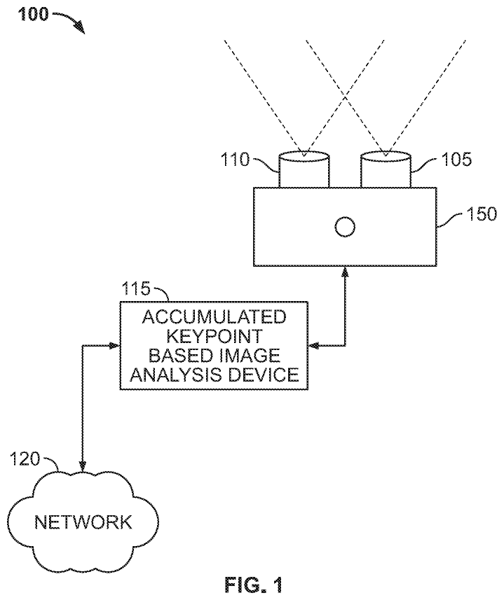

Turning to the figures, FIG. 1 is a block diagram of an exemplary stereoscopic imaging system 100 that includes an accumulated keypoint based image analysis device 115. The accumulated keypoint based image analysis device 115 is operatively coupled to imaging device 150. Imaging device 150 includes two cameras 105 and 110. Cameras 105 and 110 can capture a stereoscopic image of a scene. Imaging device 150 can be, for example, a stereo camera system with left-eye and right-eye cameras. Cameras 105 and 110 can be symmetric, or asymmetric, cameras.

Accumulated keypoint based image analysis device 115 is operable to identify and store keypoints in images taken by imaging device 150. The keypoints can be accumulated over multiple images taken at various times. The accumulated keypoints can be based on known objects in the various images. The accumulated keypoints can be stored locally or, for example, at a location accessible via network 120. Network 120 can be any wired or wireless network. For example, network 120 can be a Wi-Fi network, cellular network, Bluetooth® network, or any other suitable network. Network 120 can provide access to the Internet. Accumulated keypoint based image analysis device 115 is operable to correct depth and/or yaw errors in images taken by imaging device 150 based on the accumulated keypoints.

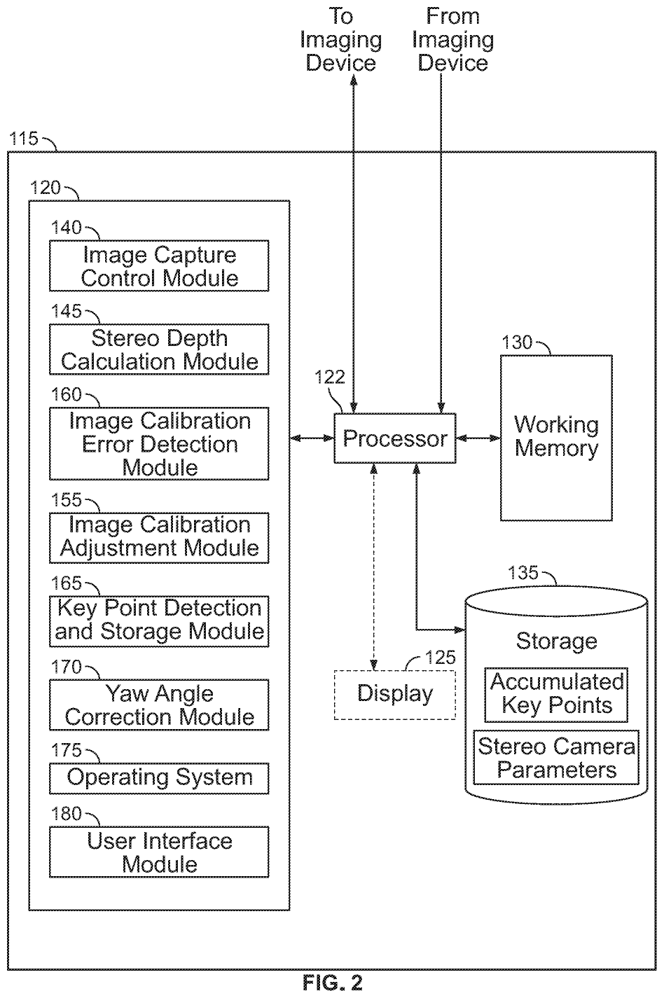

FIG. 2 provides a more detailed view of the accumulated keypoint based image analysis device 115 of FIG. 1. In some examples, accumulated keypoint based image analysis device 115 can include one or more processors, one or more field-programmable gate arrays (FPGAs), one or more application-specific integrated circuits (ASICs), one or more state machines, digital circuitry, or any other suitable circuitry. In this example, accumulated keypoint based image analysis device 115 includes processor 122, instruction memory 120, working memory 130, and storage 135. Accumulated keypoint based image analysis device 115 can also include a display 125. Display 125 can be, for example, a television, such as a 3D television, a display on a mobile device, such as a display on a mobile phone, or any other suitable display. Processor 122 can provide processed images for display to display 125. In some examples, processor 122 provided processed images to an external display.

Processor 122 can be any suitable processor, such as a microprocessor, an image signal processor (ISP), a digital signal processor (DSP), a central processing unit (CPU), a graphics processing unit (GPU), or any other suitable processor. Although only one processor 122 is illustrated, accumulated keypoint based image analysis device 115 can include multiple processors.

Processor 122 is in communication with instruction memory 120, working memory 130, and storage 135. Instruction memory 120 can store executable instructions that can be accessed and executed by processor 122. The instruction memory 120 can comprise, for example, read-only memory (ROM) such as electrically erasable programmable read-only memory (EEPROM), flash memory, a removable disk, CD-ROM, any non-volatile memory, or any other suitable memory.

Working memory 130 can be used by processor 122 to store a working set of instructions loaded from instruction memory 120. Working memory 130 can also be used by processor 122 to store dynamic data created during the operation of processor 122. Working memory 130 can be a random access memory (RAM) such as a static random access memory (SRAM) or dynamic random access memory (DRAM), or any other suitable memory.

Processor 122 can use storage 135 to store data. For example, processor 122 can store accumulated keypoints in storage 135. Processor 122 can also store stereo camera parameters in storage 135. Storage 135 can be any suitable memory, such as non-volatile memory.

In this example, instruction memory 120 includes various modules, where each module includes instructions that when executed by processor 122, causes processor 122 to perform one or more of the functions associated with the respective module. In some examples, one or more of these functions can be implemented as algorithms. In this example, instruction memory 120 includes image capture control module 140, stereo depth calculation module 145, image calibration error detection module 160, image calibration adjustment module 155, key point detection and storage module 165, yaw angle correction module 170, operating system 175, and user interface module 180.

User interface module 180 can include instructions that, when executed by processor 122, cause processor 122 to display information on an electronic display, such as display 125, accessible to a user operating accumulated keypoint based image analysis device 115. User interface module 180 can also include instructions that, when executed by processor 122, cause processor 122 to obtain information from the user that provides information to accumulated keypoint based image analysis device 115 via an input device (not shown), such as via a keyboard, stylus, touchscreen, or any other suitable input device.

Operating system module 175 can include instructions that, when executed by processor 122, cause processor 122 to manage the memory and processing resources of accumulated keypoint based image analysis device 115. For example, operating system module 175 can include device drivers to manage hardware resources such as display 125 or cameras 105 and 110. In some examples, operating system module 175 includes instructions that, when executed by processor 122, provides a software interface to these hardware resources.

Image capture control module 140 can include instructions that, when executed by processor 122, cause processor 122 to control cameras 105 and 110 of imaging device 150 to capture images of a scene. In some examples, the instructions cause the processor 122 to capture corresponding images of a first object from cameras 105 and 110 at a later time that capturing corresponding images of a second object from cameras 105 and 110.

Stereo depth calculation module 145 can include instructions that, when executed by processor 122, cause processor 122 to determine (e.g., calculate) a stereoscopic depth of an object in corresponding images (e.g., left and right images from left and right cameras, respectively) from cameras 105 and 110 of imaging device 150.

Key point detection and storage module 165 can include instructions that, when executed by processor 122, cause processor 122 to detect keypoints in captured images. The instructions can also cause processor 122 to store the keypoints in storage 135. For example, the instructions can processor 122 to receive corresponding images captured with cameras 105 and 110 from imaging device 150, and identify one or more keypoints in the images. The keypoints can be identified, for example, by locating regions of high structure content, such as edges, shapes, corners, or lines associated with objects in the image. The instructions can cause processor 122 to store the one or more keypoints as accumulated keypoints in storage 135. For example, processor 122 can identify and store keypoints from multiple images, including from images taken over a period of time. As such, processor 122 can accumulate keypoints in storage 135 over time. In some examples, processor 122 stores associated information regarding the keypoints in storage 135. For example, processor 122 can store the time of capture, the location of capture, or other information associated with the captured images in storage 135.

In some examples, the instructions can cause processor 122 to identify known objects in the captured images, and detect keypoints based on the known objects. The distance between keypoints is determined based on known dimensions for the known object. Object depths can then be estimated based on intrinsic camera parameters, such as the field of views of the cameras and camera pixel size.

Image calibration error detection module 160 can include instructions that, when executed by processor 122, cause processor 122 to detect errors, such as vertical disparity and/or yaw errors, in captured images. For example, the instructions, when executed by processor 122, can cause processor 122 to detect vertical disparity errors between corresponding images captured with cameras 105 and 110 of imaging device 150. In some examples, vertical disparity is determined by comparing the location of corresponding keypoints in an image (e.g., a location of a keypoint of an image taken by camera 105 with a location of a keypoint of the corresponding image taking by camera 110). Processor 122 can then use the vertical disparity in an optimization function to compute calibration parameters of one or more of cameras 105, 110.

Image calibration adjustment module 155 can include instructions that, when executed by processor 122, cause processor 122 to generate calibration data. The calibration data can include, for example, adjusted stereo camera parameters, such as a vertical disparity camera parameter used in calculating the vertical disparity between two cameras. For example, when processor 122, executing image calibration error detection module 160, detects depth errors, processor 122 can execute image calibration adjustment module 155 to calibrate the stereo camera parameters based on accumulated keypoints stored in storage 135.

In some examples, the vertical disparity of stored keypoints is compared to more recently captured keypoints to determine an estimated vertical disparity. In some examples, processor 122 can cross reference object depth estimations with other camera systems such as, for example, camera auto focus systems, to determine the estimated vertical disparity.

In some examples, real-time calibration of one or more of cameras 105, 110 is performed when the estimated vertical disparity is beyond a threshold. In some examples, a threshold number of estimated vertical disparities must be beyond the threshold before stereo camera parameters are calibrated. In some examples, the threshold number of estimated vertical disparities must be associated with images captured over a window of time, such as a day, a week, or any other window of time.

In some examples, processor 122 causes an indication to be provided to a user of the accumulated keypoint based image analysis device 115 when stereo camera parameters are to be re-calibrated. For example, processor 122 can cause an indication to be shown on a display 125 of the accumulated keypoint based image analysis device 115.

In some examples, the instructions, when executed by processor 122, can cause processor 122 to determine that keypoints associated with first and second images (e.g., corresponding images) of a first object and keypoints associated with first and second images of a second object were captured within a window of time. For example, the window of time can be a day, a week, a month, or any other window of time. In one or more of these examples, processor 122 can execute image calibration adjustment module 155 to calibrate the stereo camera parameters based on accumulated keypoints that were captured within the window of time. In some examples, processor 122 removes (e.g., deletes) keypoints that were captured outside of the window of time. For example, processor 122 can delete keypoints captured outside of the window of time that are stored in storage 135.

The stereo camera parameters can be calibrated based on vertical disparities of corresponding keypoints from multiple images stored in storage 135. For example, the keypoints can be associated with images taken at different times, such as on different days. In some examples, the vertical disparity can be minimized through pixel positions using the equation 1:

$${E}_{x} = \sqrt{{\sum }_{k = 1}^{K} {( {y}_{1} ( k ) - {y}_{2} ( k ) )}^{2}} = ‖ {y}_{1} - {y}_{2} ‖ \qquad ( Eq . 1 )$$

where “y_{1”} “y_{2”} are the first and second image vertical pixel values, respectively, and “k” is the index over all the keypoints.

In some examples, the instructions can cause processor 122 to execute a homogeneous linear equation solved using singular value decomposition (SVD). An example is given in Equation 2 below, where “x” and “y” determine pixel positions in the x and y directions, “f” represents a normalized focal length of a camera, and “r” is an intrinsic parameter. The first subscript to each variable represents a camera number, and the second subscript represents a keypoint number. For example, X_{2,1} represents position X in the X direction in a first keypoint from an image from camera 2. Y_{1,k} represents position Y in the Y direction in a k^{th} keypoint from an image from camera 1.

$$[ \begin{matrix}{x}_{2 , 1} {y}_{1 , 1} & {y}_{1 , 1} {y}_{2 , 1} & {f}_{2} {y}_{1 , 1} & - {x}_{2 , 1} & - {y}_{2 , 1} & - {f}_{2} \\ {x}_{2 , 2} {y}_{1 , 2} & {y}_{1 , 2} {y}_{2 , 2} & {f}_{2} {y}_{1 , 2} & - {x}_{2 , 2} & {y}_{2 , 2} & - {f}_{2} \\ {x}_{2 , K} {y}_{1 , K} & {y}_{1 , K} {y}_{2 , K} & {f}_{2} {y}_{1 , K} & - {x}_{2 , K} & - {y}_{2 , K} & - {f}_{2}\end{matrix} ] [ \begin{matrix}{r}_{31} \\ {r}_{32} \\ {r}_{33} \\ {f}_{1} {r}_{21} \\ {f}_{1} {r}_{22} \\ {f}_{1} {r}_{23}\end{matrix} ] = 0 \\ H θ = 0 \qquad ( Eq . 2 )$$

For example, X_{2,1} represents position X in a first keypoint from an image from camera 2.

In some examples, image calibration adjustment module 155 can include instructions that, when executed by processor 122, cause processor 122 to calibrate at least one of cameras 105 and 110 based on the generated calibration data.

Yaw angle correction module 170 can include instructions that, when executed by processor 122, cause processor 122 to use a known focal distance to compute the distance of a known object, and compute a yaw adjustment based on the known focal distance. For example, the instructions, when executed by processor 122, can cause processor 122 to obtain accumulated keypoints from storage 135. The keypoints can be associated with a known object in corresponding images from cameras 105 and 110 of imaging device 150. The instructions, when executed by processor 122, can cause processor 122 to compute the yaw adjustment through stereo triangulation.

For example, the difference between a center disparity and a mean disparity observed about a vertical line passing through a world origin can be used to compute the yaw angle, where both the horizontal and vertical field of views are known.

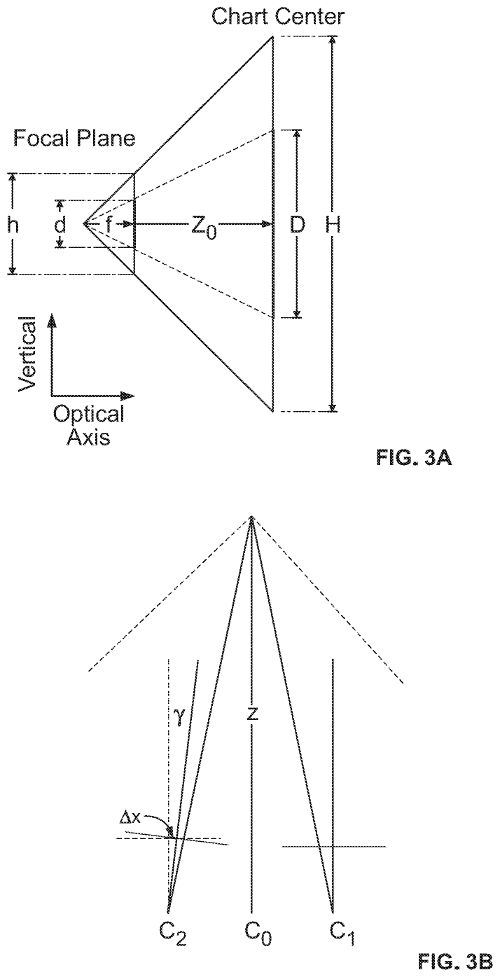

As shown in FIG. 3A, let D be the distance in millimeters (mm) between the N₀ keypoints pₖ₀⁽²⁾, k=1, . . . , N₀ located on the vertical line passing through the world origin. Given a square size α, the vertical length in mm of the line can be computed as:

D=n₀α (Eq. 3)

The corresponding length of the line in pixels at the focal plane can be computed as:

$$d = ‖ {p}_{01}^{( 2 )} - {p}_{0 {n}_{0}}^{( 2 )} ‖ \qquad ( Eq . 4 )$$

The distance in millimeters subtending the vertical field of view φᵥ⁽²⁾ can be computed as:

$${H}_{2} = \frac{{h}_{2} D}{d} \qquad ( Eq . 5 )$$

The distance to the chart Z can be computed as:

$${Z}_{0} = \frac{{H}_{2}}{2 tan ( {ϕ}_{v}^{( 2 )} / 2 )} \qquad ( Eq . 6 )$$

The horizontal distance in millimeters of the line subtending the horizontal field of view of the reference camera, φₕ⁽¹⁾, can be computed as:

$${W}_{1} = 2 Z tan \frac{{ϕ}_{h}^{( 1 )}}{2} \qquad ( Eq . 7 )$$

Let

d(i,j)=x₂(i,j)−x₁(i,j) (Eq. 8)

be the disparity at the i,jth pixel. The disparity at the chart center of FIG. 3A, assuming no yaw error, can be computed as:

$$d ( 0 , 0 ) = \frac{{f}_{1} B}{Z} = \frac{{w}_{1} B}{{W}_{1}} \qquad ( Eq . 9 )$$

FIG. 3B illustrates a diagram with a centerline C₀, a centerline C₁ of a first camera, and a centerline C₂ of a second camera. The second camera exhibits yaw errors, as is reflected by angle _{Υ}. With reference to angle _{Υ}, the yaw error can be computed as:

$$tan γ = \frac{Δ x}{{f}_{2}} = \frac{Δ x}{{Z}_{0}} \frac{{W}_{2}}{{w}_{2}} \qquad ( Eq . 10 )$$

where:

Δx=d(0,0)−\hat{d}(0,0) (Eq. 11)

is the residual disparity at the center due to unaccounted for yaw,

$${d}^{⋒} ( 0 , 0 ) = \frac{1}{{n}_{0}} {\sum }_{i = 1}^{{n}_{0}} d ( i , 0 ) \qquad ( Eq . 12 )$$

is the measured average center disparity, “Z” is the depth at the center of the chart, “W” is the horizontal field of view in millimeters, and “w” is the sensor width in pixels. An updated relative orientation matrix can be computed as:

R′₁₂=R₁₂R⁻¹(γ,0,0) (Eq. 13)

FIG. 4A illustrates the imaging device 150 of FIG. 1 with cameras 105 and 110 in relation to a yaw axis. In this example, there is no yaw error in cameras 105 and 110. FIG. 4B illustrates the imaging device 150 of FIG. 4A, but with camera 105 experiencing a yaw error. As shown in the figure, while camera 110 faces at a 90-degree angle to a horizontal surface 402, camera 105 faces at an angle less than 90 degrees to the horizontal surface 402. As a result, camera 105 exhibits a yaw error. Cameras 105 and 110 are shown facing certain angles merely for illustration. Those of ordinary skill in the art recognize that there may be yaw error between cameras 105 and 110 for various reasons, including facing in different directions.

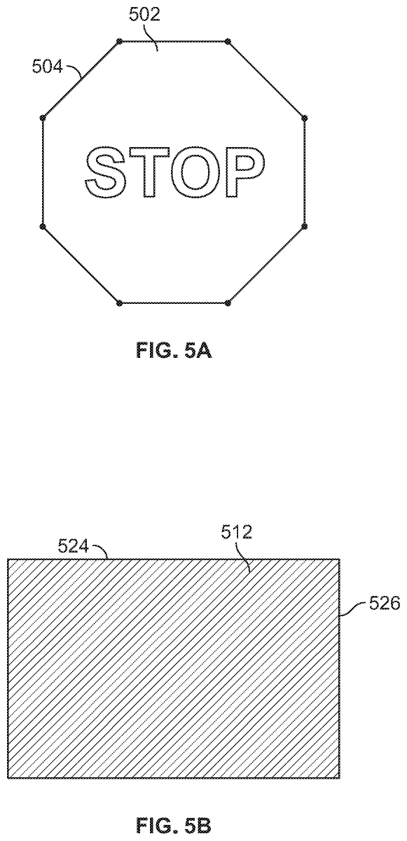

FIGS. 5A and 5B show examples of known objects that include high structure content, such as edges, shapes, corners, or lines. For example, FIG. 5A illustrates an example of a stop sign 502 that can be used by the accumulated keypoint based image analysis device 115 of FIG. 1 to calibrate stereo parameters. For example, imaging device 150 can capture an image of a scene that includes stop sign 502. Accumulated keypoint based image analysis device 115 can recognize stop sign 502 in the captured image based on, for example, known dimensions, such as known dimension for a side 504, of stop sign 502. Based on the known dimension for side 504, accumulated keypoint based image analysis device 115 can identify keypoints in the captured image and estimate the depth of the stop sign 502. Accumulated keypoint based image analysis device 115 can also store keypoints associated with side 504 of stop sign 502.

FIG. 5B illustrates another example of a known object, in this example a sheet of paper 512 with a first side 524 and a second side 526. Accumulated keypoint based image analysis device 115 can recognize a sheet of paper 512 in the captured image and, based on known dimensions for sides 524 and 526 of sheet of paper 512, estimate the depth of sheet of paper 512. Accumulated keypoint based image analysis device 115 can also determine, and store, keypoints associated with sides 524 and 526 of sheet of paper 512.

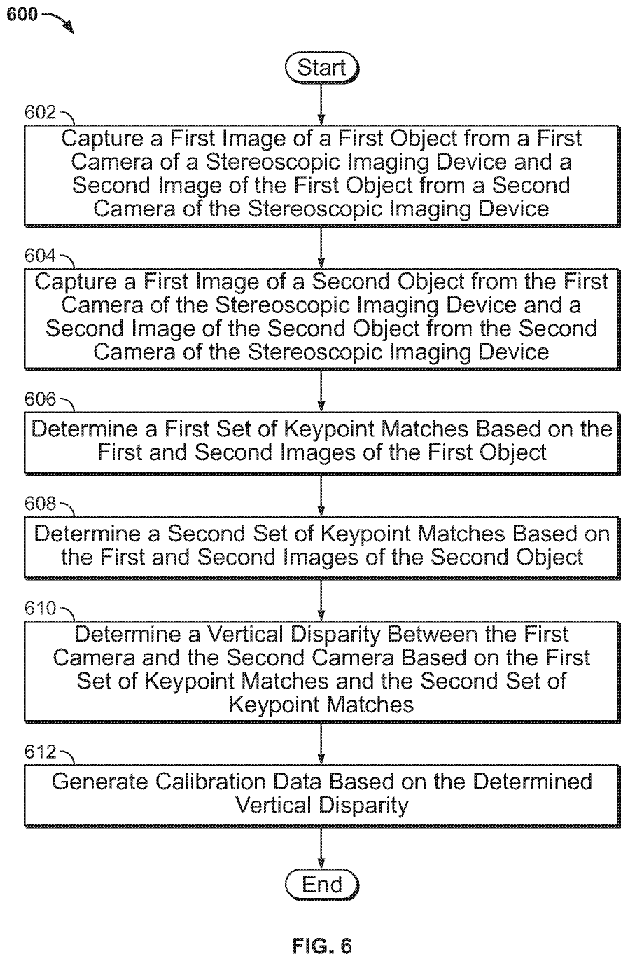

FIG. 6 is a flow chart of an exemplary method 600 by a stereoscopic imaging system, such as the stereoscopic imaging system 100 of FIG. 1. At step 602, a first image of a first object from a first camera of a stereoscopic imaging device, and a second image of the first object from a second camera of the stereoscopic imaging device, are captured. For example, the first object can be the stop sign 402 of FIG. 4A. At step 604, a first image of a second object from the first camera of the stereoscopic imaging device, and a second image of the second object from the second camera of the stereoscopic imaging device, are captured. For example, the second object can be the piece of paper 412 of FIG. 4B. At step 606, a first set of keypoint matches is determined based on the first and second images of the first object. At step 608, a second set of keypoint matches is determined based on the first and second images of the second object. At step 610, a vertical disparity between the first camera and the second camera is determined based on the first set of keypoint matches and the second set of keypoint matches. At step 612, calibration data is generated based on the determined vertical disparity. For example, the calibration data can be used to correct (i.e., reduce, minimize, or eliminate) the vertical disparity between the first camera and the second camera determined at step 610.

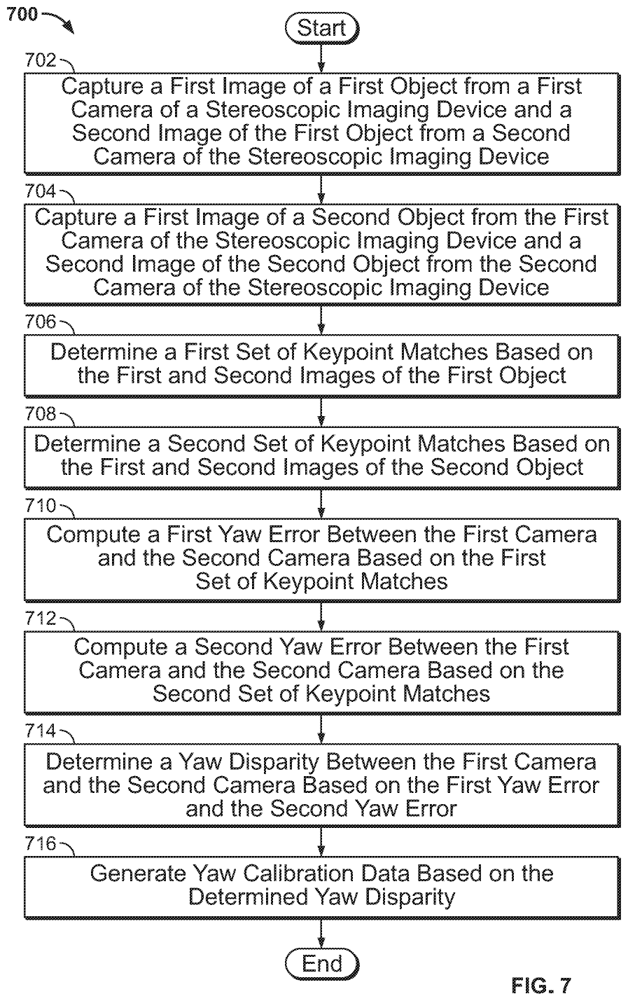

FIG. 7 is a flow chart of an exemplary method 700 by a stereoscopic imaging system, such as the stereoscopic imaging system 100 of FIG. 1. At step 702, a first image of a first object from a first camera of a stereoscopic imaging device, and a second image of the first object from a second camera of the stereoscopic imaging device, are captured. For example, the first object can be the stop sign 402 of FIG. 4A. At step 704, a first image of a second object from the first camera of the stereoscopic imaging device, and a second image of the second object from the second camera of the stereoscopic imaging device, are captured. For example, the second object can be the piece of paper 412 of FIG. 4B. At step 706, a first set of keypoint matches are determined based on the first and second images of the first object. At step 708, a second set of keypoint matches are determined based on the first and second images of the second object. At step 710, a first yaw error between the first camera and the second camera is computed based on the first set of keypoint matches. At step 712, a second yaw error between the first camera and the second camera is computed based on the second set of keypoint matches. At step 714, the yaw disparity between the first camera and the second camera is determined based on the first yaw error and the second yaw error. At step 716, yaw calibration data is generated based on the determined yaw disparity.

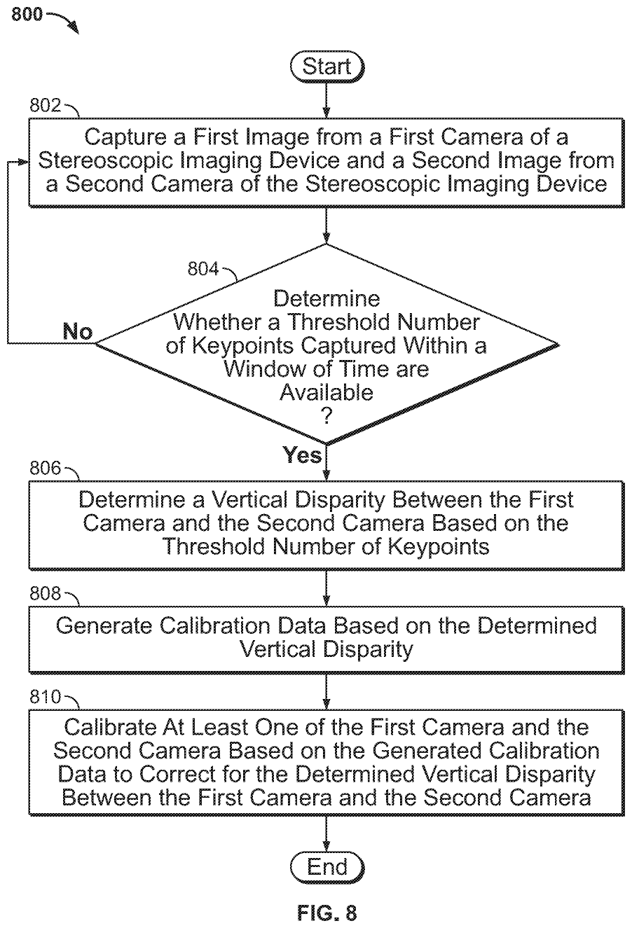

FIG. 8 is a flow chart of an exemplary method 800 by a stereoscopic imaging system, such as the stereoscopic imaging system 100 of FIG. 1. At step 802, a first image from a first camera of a stereoscopic imaging device, and a second image from a second camera of the stereoscopic imaging device, are captured. At step 804, a determination is made as to whether a threshold number of keypoints that have been captured within a window of time are available. For example, the determination can include determining whether hundreds of keypoints have been captured in the last 24 hours. In some examples, the determination can include determining whether thousands of keypoints have been captured in the last week. It is to be appreciated that other thresholds for the number of keypoints and the window of time are contemplated. In some examples, the determination as to whether a threshold number of keypoints have been captured within a window of time can include accessing a storage device, such as storage 135 of FIG. 2, to access stored keypoints and/or keypoint captured times.

If there are a threshold number of keypoints available that have been captured within the window of time, the method proceeds to step 806. Otherwise, the method proceeds back to step 802.

At step 806, a vertical disparity between the first camera and the second camera is determined based on the threshold number of keypoints. At step 808, calibration data is generated based on the determined vertical disparity. At step 810, at least one of the first camera and the second camera is calibrated based on the generated calibration data. For example, a camera parameter, such as a vertical disparity camera parameter used in calculating the vertical disparity between two cameras, is updated. The camera calibration is performed to correct for the determined vertical disparity between the first camera and the second camera.

Although the methods described above are with reference to the illustrated flowcharts, it will be appreciated that many other ways of performing the acts associated with the methods can be used. For example, the order of some operations may be changed, and some of the operations described may be optional. In addition, the steps of the methods can be embodied in hardware, in executable instructions executed by a processor (e.g., software), or in a combination of the two.

We claim:

1. A method of calibrating a stereoscopic imaging device, comprising:
capturing a first image of a first object from a first camera of the stereoscopic imaging device and a second image of the first object from a second camera of the stereoscopic imaging device;
capturing a first image of a second object from the first camera of the stereoscopic imaging device and a second image of the second object from the second camera of the stereoscopic imaging device;
determining a first set of keypoint matches based on the first and second images of the first object;
determining a second set of keypoint matches based on the first and second images of the second object;
determining a vertical disparity between the first camera and the second camera based on the first set of keypoint matches and the second set of keypoint matches; and
generating calibration data based on the determined vertical disparity.

2. The method of claim 1 further comprising calibrating at least one of the first camera and the second camera based on the generated calibration data.

3. The method of claim 2 wherein calibrating at least one of the first camera and the second camera reduces the vertical disparity between the first camera and the second camera.

4. The method of claim 1 wherein the first object and the second object are known objects.

5. The method of claim 1 further comprising storing the first set of keypoint matches and the second set of keypoint matches in a non-volatile storage device.

6. The method of claim 1, wherein the capturing of the first image of the second object and the second image of the second object is at a later time than the capturing of the first image of the first object and the second image of the first object.

7. The method of claim 1 wherein determining the vertical disparity between the first camera and the second camera further comprises retrieving the first set of keypoint matches from a non-volatile storage device.

8. The method of claim 1 further comprising determining that the first and second images of the first object and the first and second images of the second object were captured within a window of time.

9. The method of claim 1 further comprising:
determining that the first object and the second object each have a known dimension;
determining a depth of the first object based on the known dimension of the first object and a focal parameter; and
wherein determining the first set of keypoint matches is further based on the depth of the first object.

10. A method for correcting a yaw disparity between a first camera and a second camera of a stereoscopic imaging device, comprising:
capturing a first image of a first object from the first camera of the stereoscopic imaging device and a second image of the first object from the second camera of the stereoscopic imaging device;
capturing a first image of a second object from the first camera of the stereoscopic imaging device and a second image of the second object from the second camera of the stereoscopic imaging device;
determining a first set of keypoint matches based on the first and second images of the first object;
determining a second set of keypoint matches based on the first and second images of the second object;
computing a first yaw error between the first camera and the second camera based on the first set of keypoint matches;
computing a second yaw error between the first camera and the second camera based on the second set of keypoint matches;
determining the yaw disparity between the first camera and the second camera based on the first yaw error and the second yaw error; and
updating at least one calibration parameter to correct the yaw disparity between the first camera and the second camera based on the determined yaw disparity.

11. The method of claim 10 further comprising storing the first set of keypoint matches and the second set of keypoint matches in a non-volatile storage device.

12. The method of claim 10 further comprising determining that the first and second images of the first object and the first and second images of the second object were captured within a window of time.

13. The method of claim 10 further comprising generating yaw calibration data, wherein correcting the yaw disparity between the first camera and the second camera is based on the generated yaw calibration data.

14. The method of claim 13 further comprising updating calibration data of at least one of the first camera and the second camera based on the generated yaw calibration data.

15. The method of claim 13 further comprising storing the generated yaw calibration data in a non-volatile storage device.

16. A stereoscopic imaging system comprising:
a first camera;
a second camera; and
an accumulated keypoint based image analysis device configured to:
initiate capture of a first image of a first object from the first camera and a second image of the first object from the second camera;
initiate capture of a first image of a second object from the first camera and a second image of the second object from the second camera;
determine a first set of keypoint matches based on the first and second images of the first object;
determine a second set of keypoint matches based on the first and second images of the second object;
determine a vertical disparity between the first camera and the second camera based on the first set of keypoint matches and the second set of keypoint matches; and
generate calibration data for the stereoscopic imaging system based on the determined vertical disparity.

17. The stereoscopic imaging system of claim 16, wherein the accumulated keypoint based image analysis device is configured to calibrate at least one of the first camera and the second camera based on the generated calibration data.

18. The stereoscopic imaging system of claim 17, wherein the accumulated keypoint based image analysis device is configured to reduce the vertical disparity between the first camera and the second camera based on calibrating at least one of the first camera and the second camera.

19. The stereoscopic imaging system of claim 16, wherein the first object and the second object are known objects.

20. The stereoscopic imaging system of claim 16 wherein the accumulated keypoint based image analysis device comprises a non-volatile storage device, and wherein the accumulated keypoint based image analysis device is configured to store the first set of keypoint matches and the second set of keypoint matches in the non-volatile storage device.

21. The stereoscopic imaging system of claim 20, wherein the accumulated keypoint based image analysis device is configured to retrieve the first set of keypoints from the non-volatile storage device to determine the vertical disparity between the first camera and the second camera.

22. The stereoscopic imaging system of claim 16, wherein the accumulated keypoint based image analysis device is configured to store a captured time of the first and second images of the first object and a captured time of the first and second images of the second object in the non-volatile memory device.

23. The stereoscopic imaging system of claim 22, wherein the accumulated keypoint based image analysis device is configured to determine that the first and second images of the first object were captured within a window of time based on the captured time of the first and second images of the first object stored in the non-volatile memory device.

24. The stereoscopic imaging system of claim 22, wherein the accumulated keypoint based image analysis device is configured to:
determine that the first object and the second object each have a known dimension;
determine a depth of the first object based on the known dimension of the first object and a focal parameter; and
wherein determining the first set of keypoint matches is further based on the depth of the first object.

25. A stereoscopic imaging system comprising:
a first camera;
a second camera; and
an accumulated keypoint based image analysis device configured to:
capture a first image of a first object from the first camera and a second image of the first object from the second camera;
capture a first image of a second object from the first camera and a second image of the second object from the second camera;
determine a first set of keypoint matches based on the first and second images of the first object;
determine a second set of keypoint matches based on the first and second images of the second object;
compute a first yaw error between the first camera and the second camera based on the first set of keypoint matches;
compute a second yaw error between the first camera and the second camera based on the second set of keypoint matches;
determine a yaw disparity between the first camera and the second camera based on the first yaw error and the second yaw error; and
update at least one calibration parameter to correct the yaw disparity between the first camera and the second camera based on the determined yaw disparity.

26. The stereoscopic imaging system of claim 25 wherein the accumulated keypoint based image analysis device comprises a non-volatile storage device, and wherein the accumulated keypoint based image analysis device is configured to store the first set of keypoint matches and the second set of keypoint matches in the non-volatile storage device.

27. The stereoscopic imaging system of claim 26 wherein the accumulated keypoint based image analysis device is configured to determine that the first and second images of the first object and the first and second images of the second object were captured within a window of time.

28. The stereoscopic imaging system of claim 26 wherein the accumulated keypoint based image analysis device is configured to:
generate yaw calibration data based on the determined yaw disparity between the first camera and the second camera; and
update at least one calibration parameter to correct the yaw disparity between the first camera and the second camera based on generated yaw calibration data.

29. The stereoscopic imaging system of claim 28 wherein the accumulated keypoint based image analysis device is configured to calibrate at least one of the first camera and the second camera based on the generated yaw calibration data.

30. The stereoscopic imaging system of claim 28 wherein the accumulated keypoint based image analysis device is configured to store the generated yaw calibration data in a non-volatile storage device.
